(19) United States
(12) Patent Application Publication
(10) Pub. No.: US 2003/0165096 A1
(43) Pub. Date: Sep. 4, 2003

(54) Data recording device, controller for data recording device and data recording method

(75) Inventor: Yasuhisa Mashiko, Osaka (JP)

Correspondence Address: Jack Q. Lever, Jr., McDERMOTT, WILL & EMERY, 600 Thirteenth Street, N.W., Washington, DC, 20005-3096, US

(73) Assignee: Matsushita Electric Industrial Co., Ltd.

(21) Appl. No.: 10/152,688

(22) Filed: May 23, 2002

(30) Foreign Application Priority Data
May 24, 2001 (JP) 2001-156001

(51) Int. Cl. G11B 7/005

(52) U.S. Cl. 369/47.28

(57) ABSTRACT

In the case where a data recording operation is suspended, even when a synchronization pattern cannot be detected due to a scratch of an optical disk or the like, a position where the last data is recorded is precisely detected so as to resume the recording operation without causing a joint. For this purpose, in resuming the suspended recording operation in the data recording device of this invention, reproducing pattern data corresponding to a pit pattern having been recorded in the optical disk is first reproduced. A synchronization pattern detection circuit detects a synchronization pattern and outputs a pre-complementation synchronization signal. A synchronization signal complementation circuit detects presence of a synchronization signal (synchronization signal pulse) and outputs a detection/loss signal to a synchronization signal non-detection counter. Also, when the synchronization signal is lost, the synchronization signal complementation circuit complements the synchronization signal and outputs a post-complementation synchronization signal to an address detection/complementation circuit and the like. The synchronization signal non-detection counter outputs a non-complementation signal when synchronization signals are continuously lost, so as to stop the resumption of the recording operation.

### BACKGROUND OF THE INVENTION

The present invention relates to technique for a data recording device for recording data in and reproducing data from a recording medium such as an optical disk, and more particularly, such as a CD-R (compact disc recordable) or CD-RW (compact disc rewritable).

In recording data in a CD-R or CD-RW optical disk, it is necessary to complete the recording in the whole track or the whole optical disk in one recording operation as is generally designated as “track at once” or “disk at once”. Therefore, when the data recording fails, the optical disk itself may be damaged or previously recorded data may be lost. One factor of such a recording failure is, for example, a buffer underrun error. This error is caused because a buffer for temporarily holding recording data becomes empty and hence the recording operation cannot be continued when the transfer rate of the recording data from a host computer is lower than the recording rate of the optical disk unit.

As countermeasure against such a recording failure, Japanese Laid-Open Patent Publication Nos. 10-49990 and 2000-40302 disclose devices capable of once suspending a recording operation when such a recording failure occurs and resuming the recording operation afterward. When the amount of recording data held in the buffer becomes small (namely, when there arises a fear of a buffer underrun error) during a recording operation, the device suspends the recording operation and holds internal information at a point of the suspension, namely, data to be subsequently recorded (more particularly, pattern data corresponding to a pit pattern to be actually recorded and data necessary for generating the pit pattern) and information on from which clock and in which frame the recording operation is to be resumed. When a given amount of data is held in the buffer after a while from the suspension, data having been recorded is reproduced so as to detect a sub-code sink recorded lastly before the suspension. Then, PLL clocks of channel bits are counted so as to detect a recording position for subsequent data (namely, the end of the previously recorded data). Thus, the recording operation is resumed.

An example of the specific conceivable structure for performing the aforementioned suspension and resumption of a recording operation is shown in FIG. 8. In FIG. 8, a spindle motor 501 rotationally drives an optical disk 502; a motor driver circuit 503 drives the spindle motor 501; an optical head 504 records data in and reproduces data from the optical disk 502 by irradiating the optical disk 502 with laser beams and receiving reflected light from the optical disk 502; an actuator driver circuit 505 drives the optical head 504; a servo circuit 506 controls the rotation rate of the spindle motor 501 and the focusing and tracking of the optical head 504; a head amplifier 507 amplifies an RF signal output from the optical head 504 so as to output an amplified RF signal; a data slicer 508 outputs a digital signal obtained by binarizing the amplified RF signal; a clock generation circuit 509 generates a reproducing clock by using a PLL (phase locked loop); a recording resumption control unit 510 controls resumption of recording having been suspended due to a buffer underrun error or the like; a recording data decoder 511 performs processing such as de-interleave and error correction on the basis of the digital signal and the reproducing clock; a buffer memory 512 temporarily stores recording data and reproducing data; a recording data encoder 513 generates pattern data corresponding to a pit pattern to be actually recorded in the optical disk 502 by performing modulation, such as addition of an error correction code and interleave, on the recording data stored in the buffer memory 512; a recorded address detection circuit 514 extracts an address previously recorded in the optical disk 502 on the basis of the amplified RF signal output from the head amplifier 507; a laser driver circuit 515 controls the laser output of the optical head 504 on the basis of the pattern data output from the recording data encoder 513; an interface 516 transfers reproducing data and recording data to and from a personal computer 517 serving as a host; and a microprocessor 518 controls the operation of the whole data recording device.

The recording resumption control unit 510 specifically includes a synchronization pattern detection circuit 521, a resumption timing generation circuit 522, an address detection circuit 523, a comparator circuit 524 and an AND circuit 525, so as to control the resumption of recording as follows:

When the synchronization pattern detection circuit 521 detects a synchronization pattern in a reproduced digital signal, the resumption timing generation circuit 522 starts counting reproducing clocks, so as to output a timing accord signal at a H level when the count number accords with the number of clocks that are output after recording a synchronization pattern of a last frame being recorded till the suspension of the recording. When the synchronization pattern detection circuit 521 detects a synchronization pattern, the address detection circuit 523 detects an address recorded subsequently to the detected synchronization pattern, and the comparator circuit 524 compares the detected address with an address of the frame that was being recorded when the recording was suspended. When these addresses accord with each other, the comparator circuit 524 outputs an address accord signal at a H level. When both the timing accord signal output from the resumption timing generation circuit 522 and the address accord signal output from the comparator circuit 524 become a H level, the AND circuit 525 outputs a recording resuming signal at a H level to the recording data encoder 513, so that the recording can be resumed.

The timing of the resumption of recording is controlled on the basis of a frame address and the number of clocks in this manner, so that recording of data following the end of data having been recorded before the suspension can be comparatively precisely resumed without causing a joint (an overlap or a gap) or with minimizing the joint.

In the device where the recording position is detected by counting PLL clocks as described above, however, recording cannot be suitably resumed in the case where an error is caused in reproducing previously recorded data, and more particularly in reproducing a synchronization pattern because, for example, the optical disk has a scratch or a pit pattern is unstable owing to vibration caused during recording.

In other words, an optical disk is very delicate medium, and hence, recording/reproducing errors occasionally occur owing to a scratch and the like. Such an error is generally corrected through predetermined error correction processing in a general reproducing operation, so that data with such an error can be appropriately reproduced. In the case where a suspended recording operation is resumed, however, if a reproducing error occurs correspondingly to a synchronization pattern, the position where the last data before the suspension of the recording operation cannot be precisely detected, and therefore, the recording operation cannot be continuously resumed without causing a joint.

### SUMMARY OF THE INVENTION

In consideration of the aforementioned problem, an object of the invention is, even in the case where a data recording operation is suspended and a synchronization pattern cannot be detected because of a reproducing error derived from a scratch of an optical disk or the like, precisely detecting a position where last data is recorded so as to resume the recording operation without causing a joint.

In order to achieve the object, in one aspect of the invention, the controller for a data recording device for once suspending a recording operation on a recording medium and resuming the recording operation continuously from an end of recording data recorded before suspension, includes a detecting section for detecting a synchronization pattern in reproducing data obtained by reproducing the recording data; and a recording resumption timing controlling section for controlling timing of resuming the recording operation on the basis of a first synchronization pattern detected by the detecting means, and in the case where the first synchronization pattern is not detected, the recording resumption timing controlling section controls the timing of resuming the recording operation on the basis of a second synchronization pattern detected precedently to the first synchronization pattern.

Accordingly, even when the first synchronization pattern cannot be appropriately reproduced due to, for example, a scratch of the recording medium, the recording operation can be resumed as far as the preceding second synchronization pattern is detected.

Preferably, the first synchronization pattern is a synchronization pattern closest to the end of the recording data.

In the case where the synchronization pattern closest to the end of the recording data can be detected, the recording operation can be easily and appropriately resumed on the basis of this synchronization pattern.

Preferably, the controller for a data recording device further includes a synchronization signal generating section for generating a synchronization signal on the basis of the first synchronization pattern; and a clock signal generating section for generating a clock signal from the reproducing data, and the recording resumption timing controlling section controls the timing of resuming the recording operation on the basis of the synchronization signal and the clock signal.

Even when the recording operation is suspended between two synchronization signals, the recording operation can be easily resumed continuously from the end of the recording data by thus using the synchronization signal and the clock signal, specifically, for example, by counting the number of clocks on the basis of the synchronization signal.

Preferably, in the case where the first synchronization pattern is not detected, the synchronization signal generating section complements the synchronization signal on the basis of the second synchronization pattern and the clock signal.

When the synchronization signal is thus complemented by using the second synchronization pattern and the clock signal, the recording device can be controlled in the same manner as in the case where the first synchronization pattern is detected. As a result, the resumption of the recording operation can be eased.

Preferably, when the detecting section does not detect the first synchronization pattern within a range of a given number of clock signals on the basis of the second synchronization pattern, the timing of resuming the recording operation is controlled on the basis of the second synchronization pattern.

Thus, loss of the first synchronization pattern can be easily detected, so as to appropriately control the resumption of the recording operation based on the second synchronization pattern.

Preferably, the controller for a data recording device further includes a stop controlling section for stopping resumption of the recording operation when a given number of synchronization patterns are not detected continuously precedently to the first synchronization pattern.

When a given number of synchronization patterns continuously preceding to the first synchronization pattern are lost, appropriate reproducing cannot be performed in general even through a recording resuming operation because, for example, reproduced data has low quality. Therefore, in such a case, the resumption of the recording operation is stopped so as to avoid a wasteful recording resuming operation.

In another aspect of the invention, the data recording device for once suspending a recording operation on a recording medium and resuming the recording operation continuously from an end of recording data recorded before suspension includes a recording data generating section for generating data to be recorded in the recording medium; a recording section for recording the generated data to be recorded in the recording medium; a detecting section for detecting a synchronization pattern in reproducing data obtained by reproducing the recording data; and a recording resumption timing controlling section for controlling timing of resuming the recording operation on the basis of a first synchronization pattern detected by the detecting section, and in the case where the first synchronization pattern is not detected, the recording resumption timing controlling section controls the timing of resuming the recording operation performed by the recording data generating section and the recording section on the basis of a second synchronization pattern detected precedently to the first synchronization pattern.

Accordingly, even when the first synchronization pattern cannot be appropriately reproduced due to, for example, a scratch of the recording medium, the recording device can be controlled in the aforementioned manner, so as to resume the recording operation.

In still another aspect of the invention, the data recording method in which a recording operation on a recording medium is once suspended and the recording operation is resumed continuously from an end of recording data recorded before suspension, includes a detecting step of detecting a synchronization pattern in reproducing data obtained by reproducing the recording data; and a recording resumption timing controlling step of controlling timing of resuming the recording operation on the basis of a first synchronization pattern detected in the detecting step, and in the case where the first synchronization pattern is not detected, the timing of resuming the recording operation is controlled on the basis of a second synchronization pattern detected precedently to the first synchronization pattern in the recording resumption timing controlling step.

Accordingly, even when the first synchronization pattern cannot be appropriately reproduced due to, for example, a scratch of the recording medium, the recording operation can be resumed as far as the preceding second synchronization pattern is detected.

### BRIEF DESCRIPTION OF THE DRAWINGS

FIG. 1 is a block diagram for showing the whole structure of a data recording device according to an embodiment of the invention;

FIG. 2 is an explanatory diagram for showing an example of a frame format to be recorded;

FIG. 3 is a circuit diagram for showing the structure of a synchronization signal complementation circuit 122 of the data recording device;

FIG. 4 is a circuit diagram for showing the structure of a synchronization signal non-detect counter 123 of the data recording device;

FIGS. 5A, 5B, 5C, 5D and 5E are explanatory diagrams for showing an example of a recording resuming operation;

FIGS. 6A, 6B, 6C and 6D are timing charts for showing the operation of the synchronization signal complementation circuit 122;

FIG. 7 is a timing chart for showing the operations of the synchronization signal complementation circuit 122 and the synchronization signal non-detect counter 123; and

FIG. 8 is a block diagram for showing the whole structure of a data recording device in which a synchronization signal cannot be complemented.

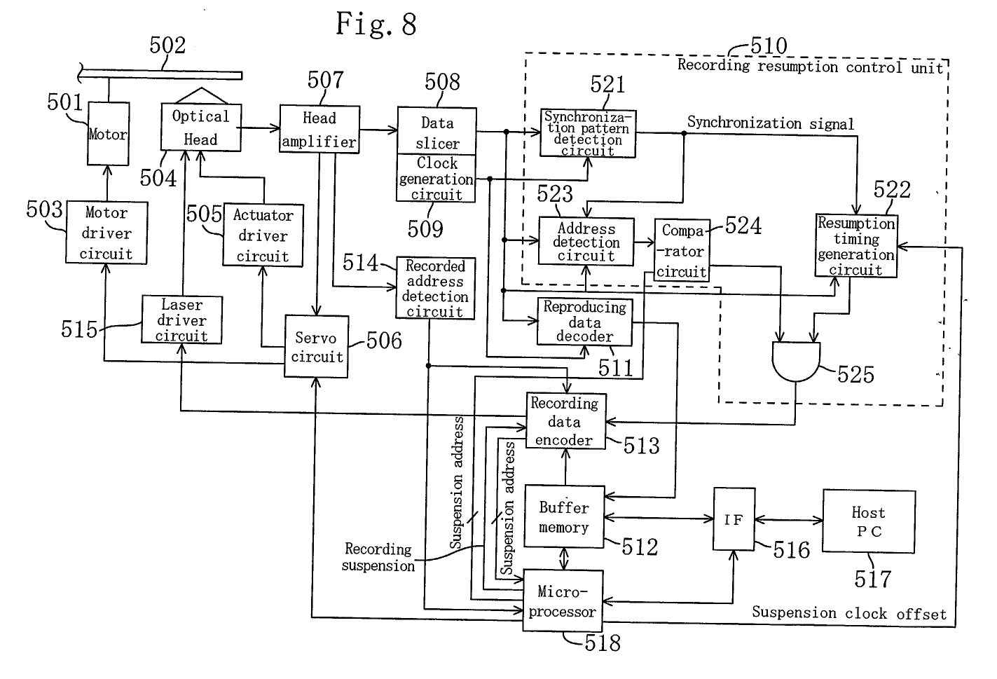

### DETAILED DESCRIPTION OF THE INVENTION

A preferred embodiment of the invention will now be described with reference to the accompanying drawings.

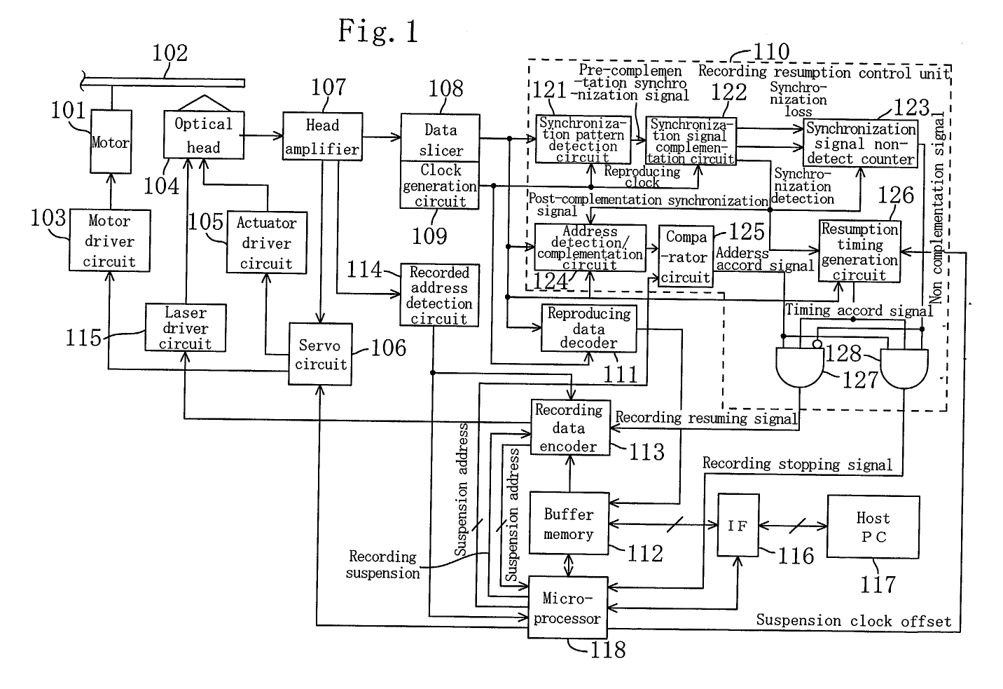

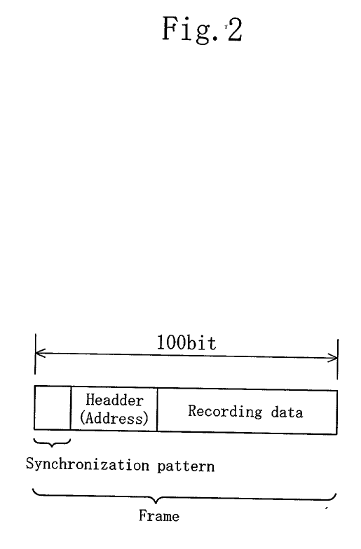

FIG. 1 is a block diagram for showing the whole structure of a data recording device according to Embodiment 1 of the invention. FIG. 2 is an explanatory diagram for showing an example of a frame format to be recorded in this recording device. In the following description, it is assumed for convenience that an address in a complete form is recorded subsequently to a synchronization pattern as shown in FIG. 2.

In FIG. 1, a spindle motor 101 rotationally drives an optical disk 102; a motor driver circuit 103 drives the spindle motor 101; an optical head 104 (recording means) records data in and reproduces data from the optical disk 102 by irradiating the optical disk 102 with laser beams and receiving reflected light from the optical disk 102; an actuator driver circuit 105 drives the optical head 104; a servo circuit 106 controls the rotation rate of the spindle motor 101 and the focusing and tracking of the optical head 104; a head amplifier 107 amplifies an RF signal output from the optical head 104 so as to output an amplified RF signal; a data slicer 108 outputs a digital signal obtained by binarizing the amplified RF signal; a clock generation circuit 109 (clock signal generating means) generates a reproducing clock by using a PLL; a recording resumption control unit 110, whose detailed structure will be described later, controls resumption of recording having been suspended due to a buffer underrun error or the like; a reproducing data decoder 111 performs processing such as de-interleave and error correction on the basis of the digital signal and the reproducing clock; a buffer memory 112 temporarily stores recording data and reproducing data; a recording data encoder 113 (recording data generating means) generates pattern data corresponding to a pit pattern to be actually recorded in the optical disk 102 by performing modulation, such as addition of an error correction code and interleave, on recording data stored in the buffer memory 112; a recorded address detection circuit 114 extracts an absolute address previously recorded in the optical disk 102 on the basis of the amplified RF signal output from the head amplifier 107; a laser driver circuit 115 controls the laser output of the optical head 104 on the basis of the pattern data output from the recording data encoder 113; an interface 116 transfers reproducing data and recording data to and from a personal computer 117 serving as a host; and a microprocessor 118 (stop controlling means) controls the operation of the entire data recording device.

The recording resumption control unit 110 specifically includes a synchronization pattern detection circuit 121 (detecting means), a synchronization signal complementation circuit 122 (synchronization signal generating means), a synchronization signal non-detect counter 123, an address detection/complementation circuit 124, a comparator circuit 125, a resumption timing generation circuit 126 (recording resumption timing controlling means), and AND circuits 127 and 128.

The synchronization pattern detection circuit 121 detects a synchronization pattern in a reproduced digital signal so as to output a pre-complementation synchronization signal.

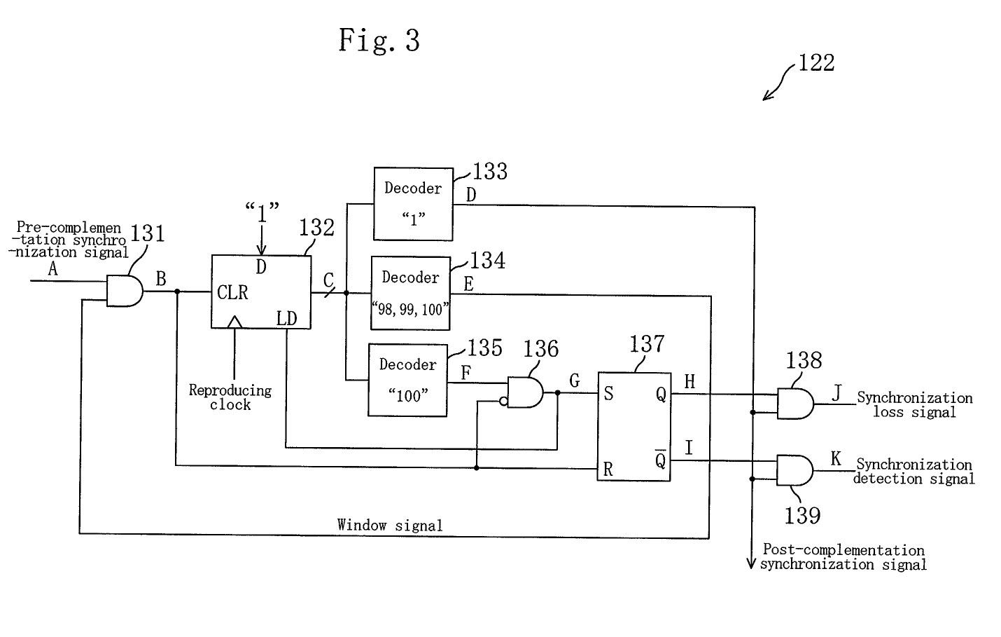

The synchronization signal complementation circuit 122 includes, for example, as shown in FIG. 3, an AND circuit 131, a counter 132, decoders 133 through 135, an AND circuit 136, a flip-flop 137 and AND circuits 138 and 139. The synchronization pattern detection circuit 121 detects the presence of a synchronization signal (synchronization signal pulse) in a pre-complementation synchronization signal, and when the synchronization signal is lost, the synchronization signal is complemented at given timing so as to output the complemented synchronization signal as a post-complementation synchronization signal.

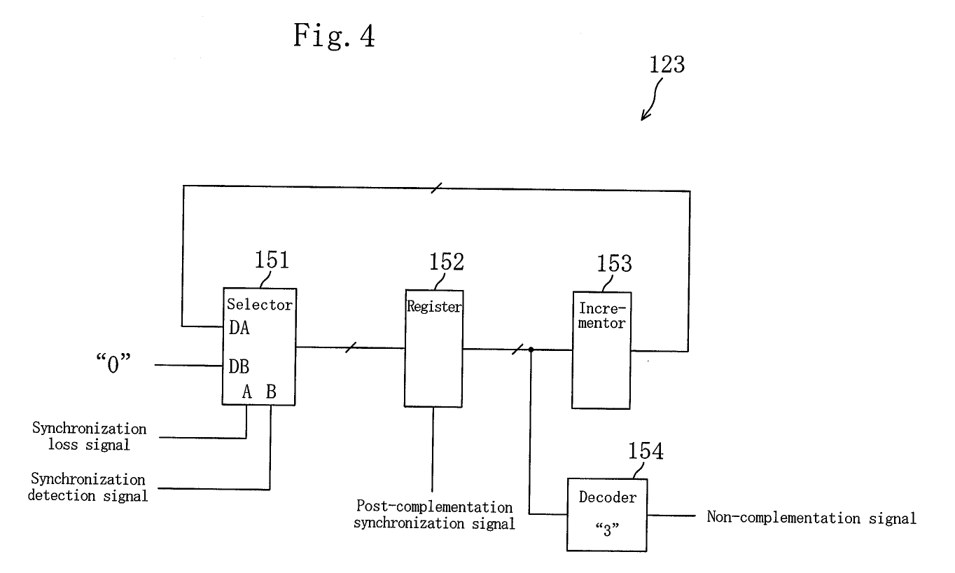

The synchronization signal non-detect counter 123 includes, for example, as shown in FIG. 4, a selector 151, a register 152, an incrementor 153 and a decoder 154. When synchronization signals are continuously lost, the synchronization signal non-detect counter 123 counts the number of lost synchronization signals, and outputs a non-complementation signal at a H level when the count number is, for example, three or more. The synchronization signal non-detect counter 123 may be, for example, a down counter in which a predetermined value is set in accordance with a synchronization detection signal and the set value is decremented in accordance with a synchronization loss signal.

The address detection/complementation circuit 124 detects an address recorded subsequently to the synchronization pattern and outputs the address when the synchronization pattern detection circuit 121 detects a synchronization pattern. Also, if an appropriate address cannot be detected, the address detection/complementation circuit 124 outputs an address obtained by incrementing the address of an immediately preceding frame.

The comparator circuit 125 compares the detected address with an address of a frame that was being recorded at the time of the suspension (namely, a suspension address). When these addresses accord with each other, the comparator circuit 125 outputs an address accord signal at a H level.

The resumption timing generation circuit 126 starts counting reproducing clocks in accordance with the post-complementation synchronization signal output from the synchronization signal complementation circuit 122. When the count value accords with the number of clocks that are output after recording a synchronization pattern of the last recorded frame till the suspension of the recording (namely, suspension clock offset), the resumption timing generation circuit 126 outputs a timing accord signal at a H level.

The AND circuit 127 outputs a recording resuming signal at a H level to the recording data encoder 113 when both the address accord signal and the timing accord signal are at a H level and the non-complementation signal is at a L level, so that the recording operation can be resumed.

Also, the AND circuit 128 outputs a recording stopping signal at a H level when all the address accord signal, the timing accord signal and the non-complementation signal are at a H level.

The operation of the data recording device having the aforementioned structure will now be described.

(Recording Operation)

The operation for recording data in the optical disk 102 is performed in the same manner as in a conventional general data recording device. Specifically, recording data transferred from the host through the interface 116 is once stored in the buffer memory 112, and thereafter is subjected to the processing such as addition of an error correction code and interleave by the recording data encoder 113. Thus, a pattern data corresponding to a pit pattern to be actually recorded is generated. When it is detected that the optical head 104 has reached a recording start point on the optical disk 102 on the basis of an address demodulated by the recorded address detection circuit 114, the generated pattern data is recorded.

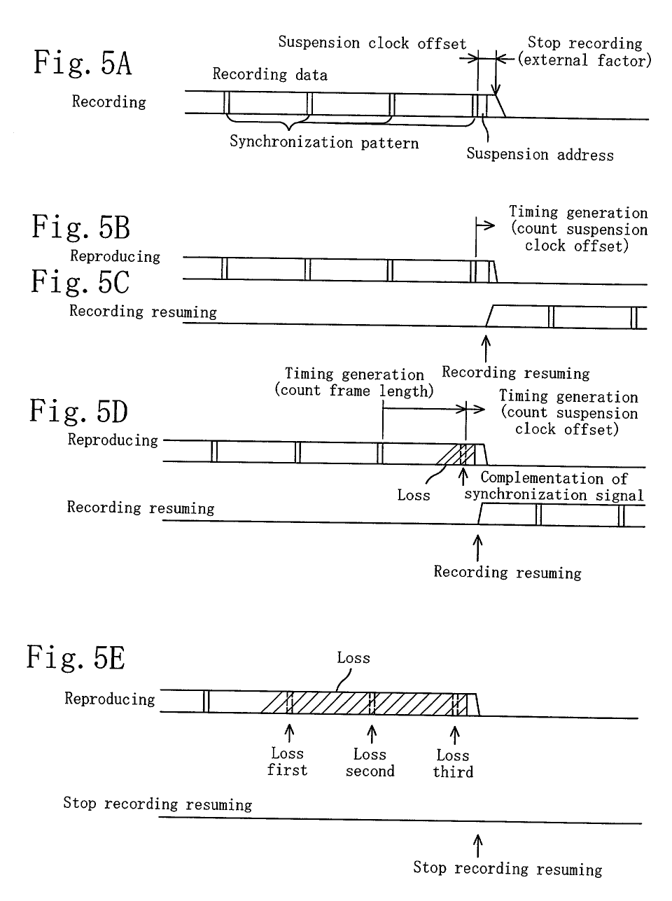

In the case where the recording operation is suspended due to a buffer underrun error or the like, an address of a frame lastly recorded (namely, a suspension address) and the number of clocks output from the position where a synchronization pattern of the lastly recorded frame is recorded to the position where the recording operation is suspended (namely, suspension clock offset) as shown in FIG. 5A are stored in a memory (not shown) connected to the microprocessor 118.

(Recording Resuming Operation)

In the case where the recording operation is to be resumed after solving the cause of the recording suspension, a position on the optical disk 102 where the recording operation was suspended, namely, the position where the recording operation is to be resumed, is first detected. Specifically, an operation similar to a general reproducing operation is performed as shown in FIG. 5B, so that a reproducing pattern data corresponding to a pit pattern recorded in the optical disk 102 can be reproduced. The reproducing pattern data is input to the synchronization pattern detection circuit 121, which detects a synchronization pattern so as to output a pre-complementation synchronization signal to the synchronization signal complementation circuit 122. The synchronization signal complementation circuit 122 detects presence of a synchronization signal (synchronization signal pulse) in the pre-complementation synchronization signal in a manner described in detail later, so as to output a detection/loss signal to the synchronization signal non-detect counter 123. Also, when the synchronization signal pulse is lost, the synchronization signal complementation circuit 122 complements the synchronization signal, so as to output a post-complementation synchronization signal to the address detection/complementation circuit 124, the resumption timing generation circuit 126 and the synchronization signal non-detect counter 123.

The address detection/complementation circuit 124 extracts the address of the frame from the reproducing pattern data output from the data slicer 108 in accordance with the post-complementation synchronization signal and outputs the extracted address to the comparator circuit 125. However, if an appropriate address cannot be extracted, the address detection/complementation circuit 124 complements the address by incrementing the address of an immediately preceding frame and outputs the complemented address.

The comparator circuit 125 compares the address output from the address detection/complementation circuit 124 with the suspension address given by the microprocessor 118, and when these addresses accord with each other, it outputs an address accord signal at a H level.

The resumption timing generation circuit 126 starts counting reproducing clocks in accordance with the post-complementation synchronization signal, and when the counted value accords with the suspension clock offset, it outputs a timing accord signal at a H level.

The synchronization signal non-detect counter 123 counts the number of lost synchronization signals as described in detail later, and when the number of lost synchronization signals is three or more, it outputs a non-complementation signal at a H level.

The AND circuit 127 outputs a recording resuming signal at a H level to the recording data encoder 113 when the address accord signal and the timing accord signal are both at a H level and the non-complementation signal is at a L level, so that the recording operation can be resumed as shown in FIG. 5C.

The AND circuit 128 outputs a recording stopping signal at a H level to the microprocessor 118 when the address accord signal, the timing accord signal and the non-complementation signal are all at a H level, and the microprocessor 118 controls the respective sections so as to stop the resumption of the recording operation.

(Detailed Operation of Synchronization Signal Complementation Circuit 122)

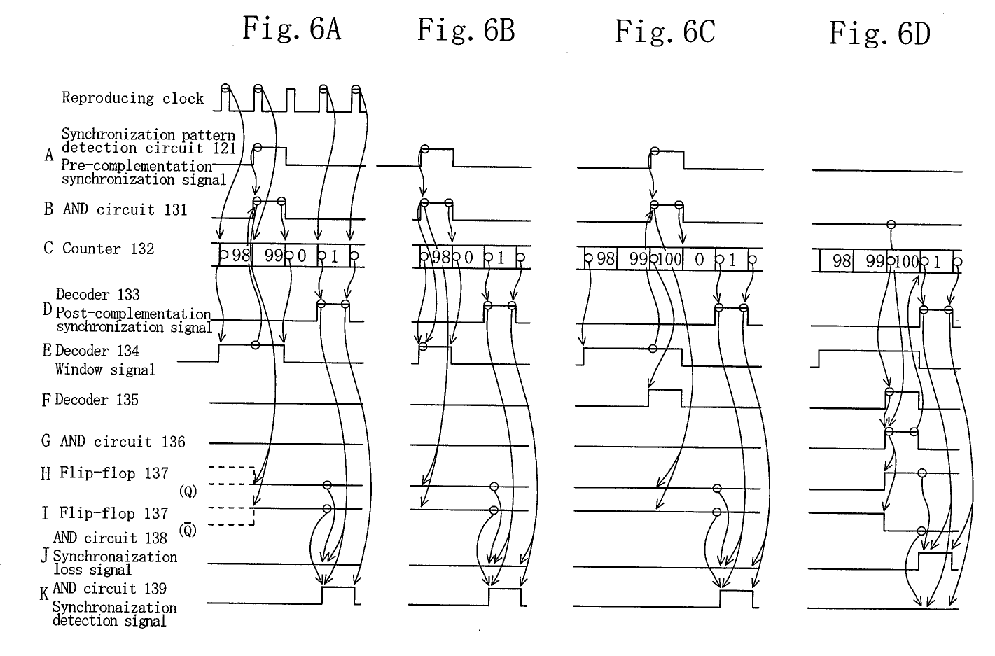

The detailed operation of the synchronization signal complementation circuit 122 (shown in FIG. 3) will now be described with reference to FIGS. 6A through 6D. As in a case of FIG. 6A, in the case where the output (E) of the decoder 134 corresponding to a window signal described later is at a H level, namely, in the case where the value (C) of the counter 132 is, for example, 99 (namely, the reproducing clock is the 100th clock from a clock following the preceding pre-complementation synchronization signal), when a subsequent pre-complementation synchronization signal (A) is input through the AND circuit 131 (B) to the clear terminal of the counter 132 and the reset terminal of the flip-flop 137, so that the value (C) of the counter 132 can be reset to 0 and that the flip-flop 137 can be reset (H and I). Thereafter, when a reproducing clock signal from the clock generation circuit 109 is input to the counter 132, the value (C) of the counter 132 is incremented to 1. In this case, the output (D) of the decoder 133 (namely, a post-complementation synchronization signal) becomes a H level to be output from the synchronization signal complementation circuit 122. Also, the post-complementation synchronization signal is input to the AND circuits 138 and 139, so that a synchronization loss signal (J) output from the AND circuit 138 can remain at a L level while a synchronization detection signal (K) output from the AND circuit 139 becomes a H level.

Furthermore, when the reproducing clock signal is input to the counter 132 and the value of the counter 132 becomes, for example, 98 (namely, the reproducing clock is the 99th clock) as in a case of FIG. 6B, the window signal (E) output from the decoder 134 becomes a H level. When a pre-complementation synchronization signal (A) is input from the synchronization pattern detection circuit 121 to the counter 132 at this point, the counter 132 is cleared so as to repeatedly count up clocks from 0 as in the aforementioned case. Moreover, if a pre-complementation synchronization signal (A) is input when the value of the counter 132 is 100 (namely, the reproducing clock is the 101st clock) as in a case of FIG. 6C, the counter 132 starts counting up clocks from 0 in the same manner. In other words, even when the phase of reproducing clocks generated by using a PLL in the clock generation circuit 109 is shifted, the count operation of the counter 132 is synchronized in accordance with every pre-complementation synchronization signal so as to count up reproducing clocks from 0.

On the other hand, when a synchronization signal is lost, the complementation is performed as follows: If a pre-complementation synchronization signal (A) is not input even when the value (C) of the counter 132 reaches 100 as in a case of FIG. 6D, the output (F) of the decoder 135 becomes a H level and the output (B) of the AND circuit 131 remains at a L level, and hence, the output (G) of the AND circuit 136 becomes a H level. The output (G) of the AND circuit 136 is input to the load terminal of the counter 132 so as to preset “1” in the counter 132 (C) and is input to the set terminal of the flip-flop 137 so as to set the flip-flop 137 (H and I). Therefore, the output (D) of the decoder 133 becomes a H level, namely, the lost synchronization signal is complemented, to be output as a post-complementation synchronization signal. Also, the synchronization loss signal (J) output from the AND circuit 138 becomes a H level while a synchronization detection signal (K) output from the AND circuit 139 remains at a L level. The synchronization loss signal (J) is used for counting the number of continuously lost synchronization signals by the synchronization signal non-detection counter 123 as described later.

In this manner, in the case where a synchronization signal is lost, a post-complementation synchronization signal obtained by complementing the lost synchronization signal on the basis of a preceding synchronization signal when the synchronization signal is found to be lost. Therefore, the operations of the resumption timing generation circuits 126 and the like can be appropriately performed, so that recording of a pit pattern can be resumed continuously with a pit pattern having been recorded before the suspension.

The reason why “1” is preset in the counter 132 when the synchronization signal is found to be lost is as follows: If the synchronization signal was appropriately detected, the timing of the synchronization signal most probably accords with time when the value of the counter 132 is 99 (namely, the reproducing clock is the 100th clock), and hence, the counter 132 is set, by presetting “1”, to the number obtained if the counter 132 was cleared when the value of the counter 132 is 99. Therefore, in the case where the range (margin) of the clock number for detecting the loss of synchronization signals is different from the aforementioned range from 99th and 101st clocks, the value to be preset in the counter 132 and the values to be detected by the decoders 133 through 135 are set in accordance with the range. In such a case, the phase of a pre-complementation synchronization signal is shifted from the phase of a post-complementation synchronization signal by several clocks. However, the other circuits such as the address detection/complementation circuit 124 can be appropriately operated in synchronization by, for example, delaying the operations of the respective circuits by the same timing.

(Detailed Operation of Synchronization Non-Detection Counter 123)

When a synchronization detection signal at a H level is input to the selection terminal B of the selector 151 of the synchronization signal non-detection counter 123 (shown in FIG. 4) and a post-complementation synchronization signal at a H level is input to the clock terminal of the register 152, a value “0” input to the selector 151 is selected to be held in the register 152. Therefore, the non-complementation signal to be output from the decoder 154 is kept at a L level.

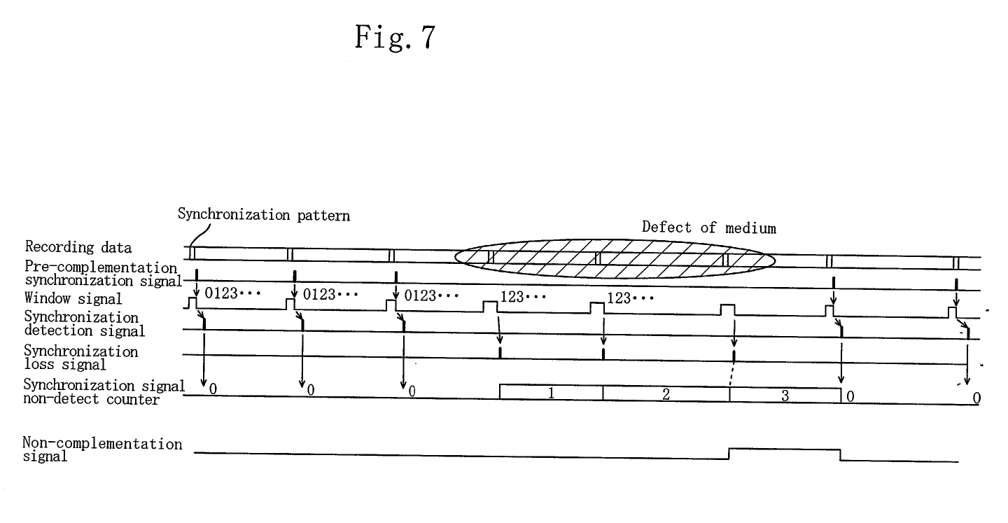

On the other hand, when a synchronization loss signal at a H level is input to the selection terminal A of the selector 151, a value obtained by incrementing the value held in the register 152 by the incrementor 153 is selected to be held in the register 152. When the synchronization loss signal at a H level is input continuously three times as shown in FIG. 7, the value held in the register 152 becomes 3, so that a non-complementation signal at a H level can be output from the decoder 154. (It is noted that, in consideration of the case where the loss of synchronization signals further continuously occurs, the incrementor 153 is preferably provided with a function as a limiter so as not to execute increment if the input value is 3.) At this point, when an address accord signal and a timing accord signal both at a H level are output respectively from the comparator circuit 125 and the resumption timing generation circuit 126, a recording resuming signal output from the AND circuit 127 is kept at a L level as described above, and hence, the recording resuming operation of the recording data encoder 113 is not started as shown in FIG. 5E. Also, a recording stopping signal output from the AND circuit 128 becomes a H level, and hence, the respective sections are controlled to stop the resumption of the recording operation by the microprocessor 118.

Specifically, as the number of continuously lost synchronization signals is larger, a synchronization signal is complemented on the basis of a further preceding synchronization signal, and therefore, the possibility of shift in the position of the synchronization signal is increased. Accordingly, in the case where a predetermined number of synchronization signals are continuously lost as described above, the resumption of the recording operation is stopped, so that the recording operation can be prevented from being wastefully resumed. The number of continuously lost synchronization signals based on which the resumption of the recording operation is stopped can be appropriately set in accordance with the recording characteristics of the data recording device and the optical disk, the quality of the optical disk and the performance required of the data recording device. Alternatively, the resumption of the recording operation may not be always controlled to be stopped in accordance with these factors.

In the above description, the frame format as shown in FIG. 2 is exemplified for convenience, which does not limit the invention. The invention is applicable to a data recording device for a CD-R or CD-RW with a synchronization pattern and an address detected and resumption timing generated in accordance with a recording format and the like of the applied recording device.

Furthermore, when a synchronization signal is lost, the resumption timing of the recording operation is controlled by complementing the lost synchronization signal in the above description, but the timing control is not limited to the complementation of the synchronization signal. The recording operation can be resumed even if a synchronization signal is lost by controlling the resumption timing substantially on the basis of a preceding synchronization signal, for example, by counting the total number of clocks output after a preceding synchronization signal.

Moreover, although the address of a frame being recorded at the time of suspending the recording operation is held to be compared with the address of a reproduced frame in the above description, the address of, for example, an immediately preceding frame can be held for comparison. In this case, the recording operation can be easily resumed even in the case where the recording operation is suspended before completely recording an address following a synchronization pattern or in the case where an address is recorded not only at the top of a frame as in Q channel data of a sub-code of a CR-ROM.

As described so far, according to the invention, in the case where a first synchronization pattern is not detected, a recording operation can be resumed on the basis of a second synchronization pattern detected precedently to the first synchronization pattern. Therefore, in the case where data recording is suspended, even when a reproducing error occurs due to a scratch of an optical disk or the like, the position where the last data is recorded can be precisely detected, so that the recording operation can be resumed without causing a joint.

What is claimed is:

1. A controller for a data recording device for once suspending a recording operation on a recording medium and resuming the recording operation continuously from an end of recording data recorded before suspension, comprising:
detecting means for detecting a synchronization pattern in reproducing data obtained by reproducing the recording data; and
recording resumption timing controlling means for controlling timing of resuming the recording operation on the basis of a first synchronization pattern detected by the detecting means,
wherein in the case where the first synchronization pattern is not detected, the recording resumption timing controlling means controls the timing of resuming the recording operation on the basis of a second synchronization pattern detected precedently to the first synchronization pattern.

2. The controller for a data recording device of claim 1,
wherein the first synchronization pattern is a synchronization pattern closest to the end of the recording data.

3. The controller for a data recording device of claim 1, further comprising:
synchronization signal generating means for generating a synchronization signal on the basis of the first synchronization pattern; and
clock signal generating means for generating a clock signal from the reproducing data,
wherein the recording resumption timing controlling means controls the timing of resuming the recording operation on the basis of the synchronization signal and the clock signal.

4. The controller for a data recording device of claim 3,
wherein in the case where the first synchronization pattern is not detected, the synchronization signal generating means complements the synchronization signal on the basis of the second synchronization pattern and the clock signal.

5. The controller for a data recording device of claim 3,
wherein when the detecting means does not detect the first synchronization pattern within a range of a given number of clock signals on the basis of the second synchronization pattern, the timing of resuming the recording operation is controlled on the basis of the second synchronization pattern.

6. The controller for a data recording device of claim 1, further comprising stop controlling means for stopping resumption of the recording operation when a given number of synchronization patterns are not detected continuously precedently to the first synchronization pattern.

7. A data recording device for once suspending a recording operation on a recording medium and resuming the recording operation continuously from an end of recording data recorded before suspension, comprising:
recording data generating means for generating data to be recorded in the recording medium;
recording means for recording the generated data to be recorded in the recording medium;
detecting means for detecting a synchronization pattern in reproducing data obtained by reproducing the recording data; and
recording resumption timing controlling means for controlling timing of resuming the recording operation on the basis of a first synchronization pattern detected by the detecting means, and
wherein in the case where the first synchronization pattern is not detected, the recording resumption timing controlling means controls the timing of resuming the recording operation performed by the recording data generating means and the recording means on the basis of a second synchronization pattern detected precedently to the first synchronization pattern.

8. A data recording method in which a recording operation on a recording medium is once suspended and the recording operation is resumed continuously from an end of recording data recorded before suspension, comprising:
a detecting step of detecting a synchronization pattern in reproducing data obtained by reproducing the recording data; and
a recording resumption timing controlling step of controlling timing of resuming the recording operation on the basis of a first synchronization pattern detected in the detecting step,
wherein in the case where the first synchronization pattern is not detected, the timing of resuming the recording operation is controlled on the basis of a second synchronization pattern detected precedently to the first synchronization pattern in the recording resumption timing controlling step.
